(19) United States
(12) Patent Application Publication
(10) Pub. No.: US 2008/0137178 A1
(43) Pub. Date: Jun. 12, 2008

(54) REFLECTION-TYPE OPTICAL MODULATOR MODULE

(76) Inventors: Yong Duck CHUNG, Daejeon (KR); Kwang Seong CHOI, Seoul (KR); Jae Sik SIM, Daejeon (KR); Je Ha KIM, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/949,934

(22) Filed: Dec. 4, 2007

(30) Foreign Application Priority Data
Dec. 6, 2006 (KR) 10-2006-0123148
Jun. 12, 2007 (KR) 10-2007-0057091

(51) Int. Cl. G02F 1/00

(52) U.S. Cl. 359/321; 359/238

(57) ABSTRACT

Provided is a reflection-type optical modulation module. According to the reflection-type optical modulation module, an anti-reflective thin film is formed on the optical input/output side surface of a waveguide to reduce optical coupling loss, and also a high-reflective thin film is formed on the opposite side surface to feed back a modulated optical signal. Thus, even when the length of an absorption layer is shortened, a sufficient optical path length is available, and it is possible to obtain a sufficient extinction ratio. Since the optical path length is sufficiently long despite a reduction in the length of the device, capacitance is reduced, and high-speed operation is enabled. In addition, only one lensed optical fiber for optical input and output is used, and thus it is possible to reduce production cost and the number of installation processes. Furthermore, a small-sized and low-priced optical amplifier, instead of an external amplifier which is high priced and has a large volume, is integrated with an optical modulator so that production cost can be further reduced.

### CROSS-REFERENCE TO RELATED APPLICATION

This application claims priority to and the benefit of Korean Patent Application No. 2006-123148, filed Dec. 6, 2006, and No. 2007-57091, filed Jun. 12, 2007, the disclosures of which are incorporated herein by reference in their entirety.

### BACKGROUND

1. Field of the Invention

The present invention relates to a reflection-type optical modulator module, and more particularly, to a reflection-type optical modulator module that has an anti-reflective thin film formed on an optical input/output (I/O) side and a high-reflective thin film formed on the opposite side to obtain a sufficient extinction ratio using the short length of an absorption layer, and that has an optical amplifier integrated therein to be implemented in a small size at low cost.

The present invention has been produced from the work supported by the IT R&D program of MIC (Ministry of Information and Communication)/IITA (Institute for Information Technology Advancement) [2005-S-039-02, SoP (System on Package) for 60 GHz Pico cell Communication] in Korea.

2. Discussion of Related Art

In general, an electro-absorption optical modulator used for modulating signals in digital optical communication is a device that adjusts the intensity of output light according to an input electric signal by regulating the intensity of incident light. Here, the modulated digital signals are classified into a signal having a larger intensity than a predetermined reference and another signal not having such a large intensity. In digital communication, an “extinction ratio” is defined as a unit of intensity whereby on and off states can be distinguished. The extinction ratio varies depending on optical modulator's ability to absorb light, and a multiple-quantum-well optical modulator generally has an extinction ratio of about 20 dB. When the intensity of output light increases together with the extinction ratio, an Optical Signal-to-Noise Ratio (OSNR) in digital communication increases, and thus system performance may be improved. Therefore, digital optical modulators must have a high extinction ratio and be able to operate at high input optical power.

In analog optical transmission, an output optical intensity is modulated according to an electric signal having a predetermined frequency and transferred through an optical fiber, and then the electric signal is restored from the optical signal. An optical modulator used in such analog optical transmission is employed as an essential signal source of Radio-Over-Fiber (ROF) link optical transmission technology that converts a Radio Frequency (RF) signal containing a digitally modulated signal into an optical signal and transfers the converted signal through an optical fiber. In this case, a ratio of an RF signal input to the optical modulator to an RF signal restored by an optical detector is defined as an RF gain. Further, it is very important to obtain high RF gain in the ROF link optical transmission technology. From the viewpoint of the optical modulator, the RF gain is proportional to the square of output optical power and to the slope of a modulator transfer function. Therefore, an analog optical modulator is required to operate at high input optical power, and also the slope of its transfer function must be steep.

Operating speed of recent digital and analog communication has been gradually increasing. Here, the operating speed of an electro-absorption modulator is inversely proportional to its capacitance. Therefore, the size of an optical modulator must be reduced to increase its operating speed, which leads to a reduction in its extinction ratio. Consequently, there is a limit to the speed of an electro-absorption modulator that maintains a certain extinction ratio.

A conventional electro-absorption optical modulator will be described below with reference to the drawings.

FIG. 1 is a plan view of a conventional electro-absorption optical modulator.

Referring to FIG. 1, a conventional electro-absorption optical modulator 10 comprises a waveguide 11 in which an optical modulator absorption layer (not shown) having a multiple-quantum-well structure (InGaAsP/InGaAsP) is formed, a p-type ohmic metal 12, an electrode for wire bonding, and anti-reflective thin films 14 deposited on both sections of the waveguide 11 to reduce insertion loss. Lensed optical fibers OF are prepared at the both sides of the waveguide 11, respectively. In general, incident light is absorbed by the absorption layer alone. When the device includes an absorption layer having a length of 50 to 100 μm, the size of the device is too small to form an electrode for RF input and output, and it is very difficult to actually manufacture the device due to its small size. To solve these problems, a layer not absorbing light is generally prepared on both sides of the absorption layer, which is referred to as a passive waveguide. In a general electro-absorption optical modulator, passive waveguides exist on both sides of an absorption layer.

In the thus constituted optical modulator, two optical fibers for optical input and output are aligned and used. One of the two optical fibers is for inputting a continuous wave before modulation, and the other is for outputting a modulated wave. Since conventional optical modulators require a process of optically aligning two optical fibers at both sections of a waveguide for the sake of optical input and output, a manufacturing process is added and production cost increases.

Meanwhile, the intensity of optical power output from an optical modulator has very significant influence on improvement of communication performance. Upon optical coupling between an optical modulator and an optical fiber, optical loss is caused by discordance of optical modes, which leads to a reduction in the intensity of output light.

To solve these problems, a method of connecting an Erbium-Doped Fiber-optical Amplifier (EDFA) or a Semiconductor Optical Amplifier (SOA) to an optical modulator to compensate for optical output power reduced due to optical coupling loss is generally used. However, when such an additional amplifier is used out of an optical modulator, production cost increases.

### SUMMARY OF THE INVENTION

The present invention is directed to a reflection-type optical modulator module that has an anti-reflective thin film coated on an optical input/output surface of a waveguide and a high-reflective thin film coated on the opposite surface, and thus has a sufficient extinction ratio using a short length of an absorption layer and enables high-speed modulation.

The present invention is also directed to a reflection-type optical modulator module that has an anti-reflective thin film coated on an optical input/output surface and one optical fiber aligned with the optical input/output surface, thus enabling reductions in production cost and the number of installation processes.

The present invention is also directed to a reflection-type optical modulator module that has a small-sized and low-priced optical amplifier integrated therein, instead of an external amplifier which is high priced and has a large volume, thus enabling a reduction in production cost.

One aspect of the present invention provides a reflection-type optical modulator module, comprising: a waveguide including an absorption layer formed on a substrate; an anti-reflective thin film formed on one side surface of the waveguide; and a high-reflective thin film formed on the other side surface of the waveguide.

Another aspect of the present invention provides a reflection-type optical modulator module, comprising: an optical modulator for modulating an optical signal input from an optical fiber; and an optical amplifier integrated at a front end of the optical modulator and amplifying the optical signal, wherein an anti-reflective thin film for reducing optical coupling loss between the optical amplifier and the optical fiber is formed on an optical input/output side surface of the optical amplifier, and a high-reflective thin film for feeding back the modulated optical signal is formed on a rear side surface of the optical modulator.

The anti-reflective thin film may be formed of TiO₂ and SiO), and the high-reflective thin film may be formed of SiO₂ and Si. The anti-reflective thin film may have a reflectance of 0 to 1%, and the high-reflective thin film may have a reflectance of 99 to 100%. One lensed optical fiber for inputting and outputting the optical signal may be aligned with a region adjacent to the anti-reflective thin film.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a plan view of a conventional electro-absorption optical modulator;

FIG. 2 is a plan view of a reflection-type optical modulator module according to a first exemplary embodiment of the present invention;

FIG. 3 is a side sectional view of the reflection-type optical modulator module taken along line III-III of FIG. 2;

FIG. 4 is a plan view of a reflection-type optical modulator module according to a second exemplary embodiment of the present invention;

FIG. 5 is a perspective cut-away view of a reflection-type optical modulator module implemented by a selective area growth method and a regrowth method according to the second exemplary embodiment of the present invention; and

FIG. 6 is a perspective view of a reflection-type optical modulator module implemented using a lithography method according to the second exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

### First Exemplary Embodiment

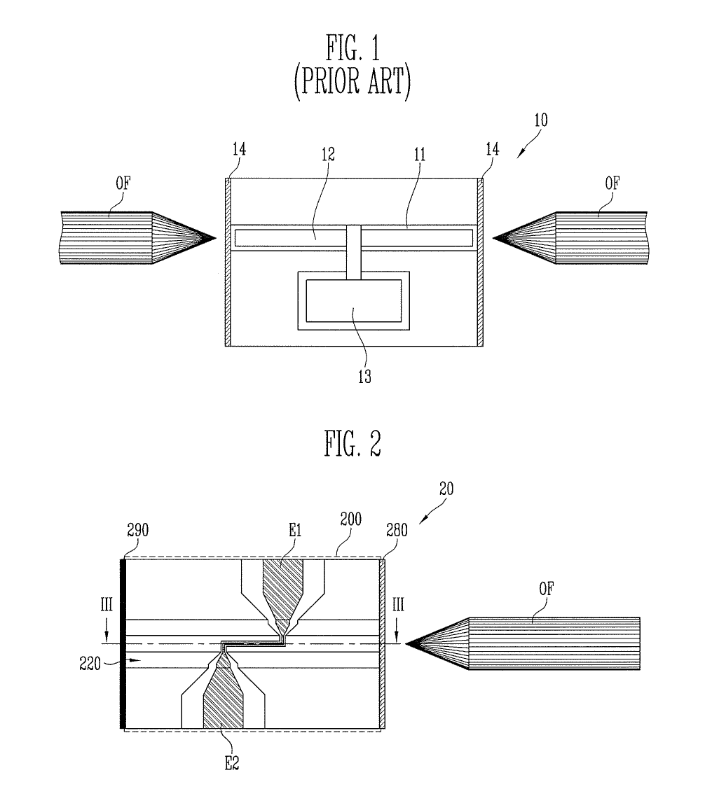

FIG. 2 is a plan view of a reflection-type optical modulator module 20 according to a first exemplary embodiment of the present invention, and FIG. 3 is a side sectional view of the reflection-type optical modulator module 20 taken along line III-III of FIG. 2.

Referring to FIGS. 2 and 3, the reflection-type optical modulator module 20 according to the first exemplary embodiment of the present invention comprises an optical modulator 200 for modulating an optical signal input from an optical fiber OF, and an anti-reflective thin film 280 and a high-reflective thin film 290 formed on both side surfaces of the optical modulator 200.

The optical modulator 200 comprises a substrate 210, a first clad layer 230 formed on the substrate 210, an absorption layer 240 formed on the first clad layer 230, a second clad layer 250 formed on the absorption layer 240, and a surface protection layer 260, and a metal layer 270 formed on the second clad layer 250. Here, the first clad layer 230, the absorption layer 240, and the second clad layer 240 constitute a waveguide 220.

In the optical modulator 200, the anti-reflective thin film 280 is formed on one side surface, through which optical input and output is made, to reduce input and output loss of the waveguide 220, and the high-reflective thin film 290 is formed on the opposite side surface to feed back an optical signal.

In the uppermost part of the optical modulator 200, first and second electrodes E1 and E2 to which an electric signal is input are connected with the metal layer 270. The metal layer 270 and the first and second electrodes E1 and E2 may be formed in one body.

Meanwhile, the lensed optical fiber OF is prepared at one side of the optical modulator 200, that is, an input/output end of the waveguide 220 on which the anti-reflective thin film 280 is formed, and a lens (not shown) is installed in the optical fiber OF. In the present invention, the lensed optical fiber OF is formed at the side of the anti-reflective thin film 280.

The components of the optical modulator 200 will be described here in further detail. As the substrate 210, a semi-insulating substrate is used for high-speed operation. In this exemplary embodiment, an InP substrate is used. The first and second clad layers 230 and 250 are formed of InGaAsP and have different conductivities. For example, when the first clad layer 230 is an n+ InGaAsP layer, the second clad layer 250 is a p+ InGaAsP layer. The absorption layer 240 is an optical modulator absorption layer having an InGaAsP/InGaAsP multiple-quantum-well structure. The metal layer 270 is formed of Ti/Pt/Au and has the form of an electrode connected with the first and second electrodes E1 and E2 for high-speed operation. A traveling-wave power source is used for the first and second electrodes E1 and E2 for high-speed operation.

In general, incident light is absorbed by the absorption layer 240 alone. When the device includes an absorption layer having a length of 50 to 100 μm, the size of the device is too small to form an electrode for RF input and output, and it is very difficult to actually manufacture the device due to its small size. To solve these problems, a layer not absorbing light is generally prepared on both sides of the absorption layer, which is referred to as a passive waveguide. In a general reflection-type optical modulator module, passive waveguides exist on both sides of an absorption layer. However, in the present invention, passive waveguides may exist on the both sides 251, 252 of the absorption layer 240 or in a side 252 in which the anti-reflective thin film 280 is formed because input and output is performed in one side. Needless to say, an optical modulator including an absorption layer may be manufactured without a passive waveguide.

The waveguide 220 of the optical modulator 200 is formed in an InGaAsP/InGaAsP multiple-quantum-well structure or formed of InP. The length of the waveguide 220 is 50 to 100 μm, and the length of the absorption layer 240 is proportional to the length of the waveguide 220. In other words, since the length of the waveguide 220 ranges from 50 to 100 μl, the length of the absorption layer 240 also ranges from 50 to 100 μm. To reduce input and output loss of the waveguide 220, the anti-reflective layer 280 is deposited on a section, through which optical input and output is made, and the high-reflective thin film 290 for feeding back an optical signal is deposited on the opposite section. The anti-reflective thin film 280 is composed of a TiO₂ layer and a SiO2₉ layer. Here, TiO₂ is deposited to a thickness of about 120 nm, and SiO₂ is deposited to a thickness of about 195 nm. When the anti-reflective thin film 280 is formed in this way, the reflectance of the anti-reflective thin film 280 ranges from 0.0001 to 1%. In this exemplary embodiment, it is 0.0001%, and thus reflection hardly occurs. On the other hand, the high-reflective thin film 290 is composed of two pairs of SiO2₂ and Si layers stacked to a thickness of ¼ of a wavelength of incident light. In this case, the high-reflective thin film 290 has a reflectance of 99 to 100%.

As described above, the reflection-type optical modulator module 20 according to the first exemplary embodiment of the present invention has the anti-reflective thin film 280 for reducing optical coupling loss formed on the optical input/output side surface and the high-reflective thin film 290 for feeding back an optical signal formed on the opposite side surface. Thus, it is possible to obtain a sufficient extinction ratio using the short length of the absorption layer 240, and high-speed operation is enabled. In addition, light can be input and output through the one lensed optical fiber OF optically aligned with the input/output side surface of the waveguide 220 on which the anti-reflective thin film 280 is formed. Thus, by using the lensed optical fiber OF prepared at only one side surface of the waveguide 220, it is possible to reduce production cost and the number of installation processes.

### Second Exemplary Embodiment

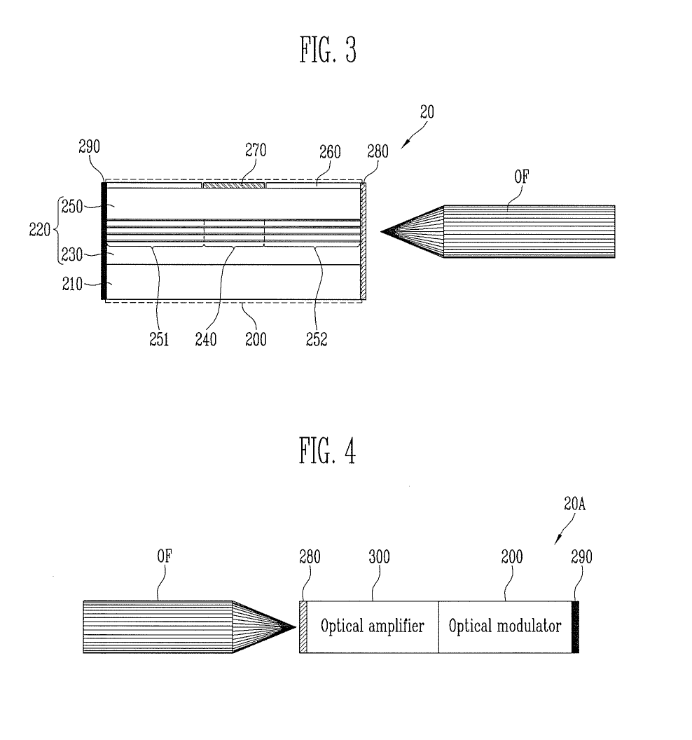

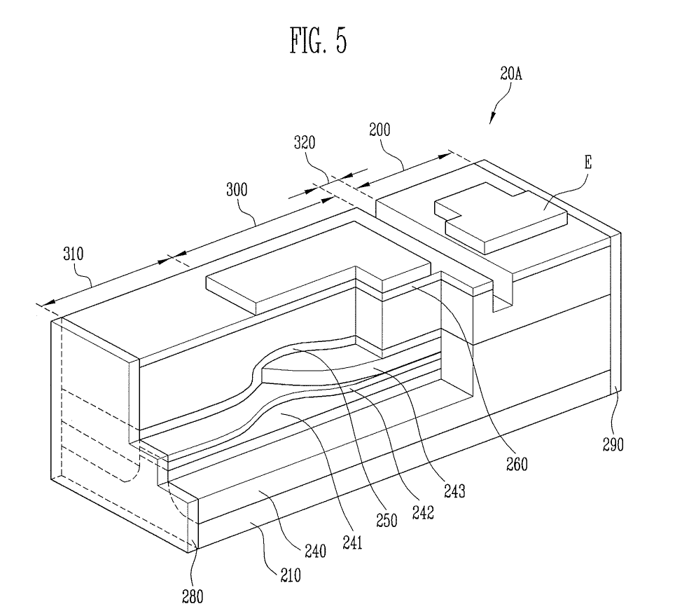

FIG. 4 is a plan view of a reflection-type optical modulator module 20A according to a second exemplary embodiment of the present invention.

Referring to FIG. 4, the reflection-type optical modulator module 20A according to the second exemplary embodiment of the present invention comprises the same components as the reflection-type optical modulator module 20 of FIG. 2, except that an optical amplifier 300 is integrated with an optical modulator 200.

More specifically, the small optical amplifier 300 is integrated at the front end of the optical modulator 200, an anti-reflective thin film 280 is formed on the optical input/output side surface of the optical amplifier 300, and a high-reflective thin film 290 is formed on a rear side surface of the optical modulator 200, thereby forming the reflection-type optical modulator module 20A according to the second exemplary embodiment of the present invention.

According to the thus constituted optical modulator module 20A, an optical signal input through the lensed optical fiber OF is transferred to the optical amplifier 300 through the anti-reflective thin film 280 without being reflected to the outside. Then, the optical amplifier 300 amplifies and transfers the optical signal attenuated due to optical coupling loss to the optical modulator 200. Subsequently, the optical modulator 200 modulates and outputs the optical signal amplified by the optical amplifier 300. Here, the modulated optical signal is reflected and fed back by the high-reflective thin film 290 formed on the rear side surface of the optical modulator 200.

Therefore, the reflection-type optical modulator module 20A according to the second exemplary embodiment of the present invention can compensate for the intensity of an optical signal attenuated due to the optical coupling loss without using a high-priced external amplifier having a large volume. Thus, in comparison with the reflection-type optical modulator module 20 of FIG. 2, it is possible to further reduce production cost.

FIG. 5 is a perspective cut-away view of a reflection-type optical modulator module 20A implemented by a selective area growth method and a regrowth method according to the second exemplary embodiment of the present invention.

Referring to FIG. 5, the reflection-type optical modulator module 20A according to the second exemplary embodiment of the present invention comprises an optical modulator 200 for modulating an optical signal input from an optical fiber (not shown), and an optical amplifier 300 integrated at the front end of the optical modulator 200 and amplifying the optical signal. On the optical input/output side surface of the optical amplifier 300, an anti-reflective thin layer 280 for reducing optical coupling loss between the optical amplifier 300 and the optical fiber is formed. On a rear side surface of the optical modulator 200, a high-reflective thin film 290 for feeding back the modulated optical signal is formed.

Here, a mode converter 310 for smoothly converting the optical mode of an optical signal is further disposed at the front end of the optical amplifier 300, and a separation groove 320 for electrically separating the optical amplifier 300 from the optical modulator 200 is formed therebetween.

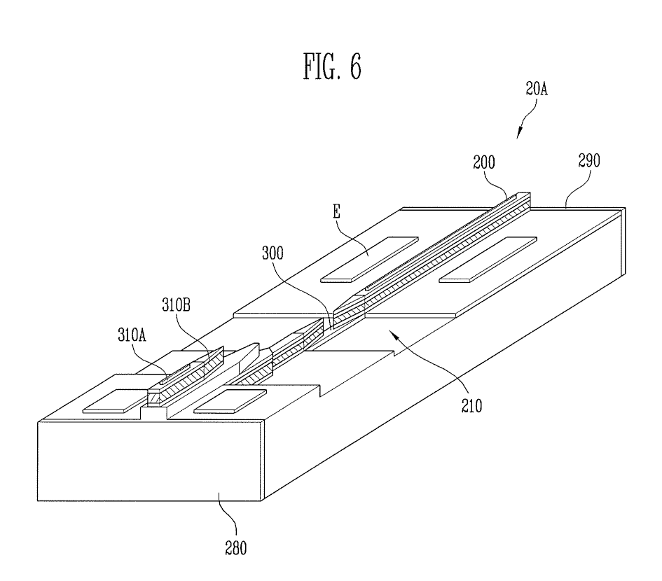

Meanwhile, FIG. 6 is a perspective view of a reflection-type optical modulator module 20A implemented using a lithography method according to the second exemplary embodiment of the present invention.

Referring to FIG. 6, the reflection-type optical modulator module 20A according to the second exemplary embodiment of the present invention comprises an optical modulator 200 for modulating an optical signal input from an optical fiber (not shown), and an optical amplifier 300 integrated at the front end of the optical modulator 200 and amplifying the optical signal. On an optical input/output side surface of the optical amplifier 300, an anti-reflective thin layer 280 for reducing optical coupling loss between the optical amplifier 300 and the optical fiber is formed. On a rear side surface of the optical modulator 200, a high-reflective thin film 290 for feeding back the modulated optical signal is formed.

Here, the optical amplifier 300 further comprises first and second mode converters 310A and 310B for smoothly converting an optical mode of the optical signal.

The reflection-type optical modulator modules constituted as shown in FIGS. 5 and 6 have reduced optical coupling loss due to the anti-reflective thin film 280, and feed back an optical signal by the high-reflective thin film 290. Therefore, a sufficient extinction ratio can be obtained using a short length of an absorption layer, and high speed operation is enabled. In addition, since light can be input and output through the one lensed optical fiber OF optically aligned with each module, it is possible to reduce production cost and the number of installation processes. Furthermore, intensity of an optical signal reduced due to optical coupling loss can be compensated without using an external amplifier, which is high priced and has a large volume, so that production cost can be further reduced.

According to the present invention, an anti-reflective thin film is formed on an optical input/output side surface to reduce optical coupling loss, and also a high-reflective thin film is formed on the opposite side surface to feed back a modulated optical signal. Thus, even when the length of an absorption layer is shortened, a sufficient optical path length is available, and it is possible to obtain a sufficient extinction ratio. Since the optical path length is sufficiently long despite a reduction in the length of the device, capacitance is reduced, and high-speed operation is enabled.

In addition, according to the present invention, only one lensed optical fiber for optical input and output is used, and thus it is possible to reduce installation cost by at least half.

Furthermore, according to the present invention, a small-sized and low-priced optical amplifier, instead of an external amplifier which is high priced and has a large volume, is integrated with an optical modulator so that production cost can be further reduced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A reflection-type optical modulator module, comprising:
a waveguide including an absorption layer formed on a substrate;
an anti-reflective thin film formed on one side surface of the waveguide; and
a high-reflective thin film formed on the other side surface of the waveguide.

2. The reflection-type optical modulator module of claim 1, wherein one lensed optical fiber for inputting and outputting an optical signal is aligned with a region adjacent to the anti-reflective thin film.

3. The reflection-type optical modulator module of claim 1, wherein the anti-reflective thin film is formed of TiO₂ and SiO₂, and the high-reflective thin film is formed of SiO₂ and Si.

4. The reflection-type optical modulator module of claim 3, wherein the anti-reflective thin film has a reflectance of 0 to 1%, and the high-reflective thin film has a reflectance of 99 to 100%.

5. The reflection-type optical modulator module of claim 1, wherein the waveguide comprises:
a first clad layer formed on the substrate;
the absorption layer formed on the first clad layer; and
a second clad layer formed on the absorption layer.

6. The reflection-type optical modulator module of claim 5, wherein the absorption layer has an InGaAsP/InGaAsP multiple-quantum-well structure and has a length of 50 to 100 μm.

7. The reflection-type optical modulator module of claim 5, wherein the waveguide has a length of 50 to 100 μm.

8. The reflection-type optical modulator module of claim 1, further comprising:
at least one electrode formed on the waveguide.

9. The reflection-type optical modulator module of claim 8, wherein traveling-wave power is applied to the electrode.

10. The reflection-type optical modulator module of claim 1, wherein the substrate is a semi-insulating substrate.

11. A reflection-type optical modulator module, comprising:
an optical modulator for modulating an optical signal input from an optical fiber; and
an optical amplifier integrated at a front end of the optical modulator and amplifying the optical signal,
wherein an anti-reflective thin film for reducing optical coupling loss between the optical amplifier and the optical fiber is formed on an optical input/output side surface of the optical amplifier, and a high-reflective thin film for feeding back the modulated optical signal is formed on a rear side surface of the optical modulator.

12. The reflection-type optical modulator module of claim 11, wherein the optical modulator and the optical amplifier are formed by a selective area growth method and a regrowth method, or a photolithography process and an etching process.

13. The reflection-type optical modulator module of claim 11, wherein the optical amplifier further comprises a mode converter for converting an optical mode of the optical signal.

14. The reflection-type optical modulator module of claim 11, wherein one lensed optical fiber for inputting and outputting an optical signal is aligned with a region adjacent to the anti-reflective thin film.

15. The reflection-type optical modulator module of claim 11, wherein the anti-reflective thin film is formed of TiO₂ and SiO₂, and the high-reflective thin film is formed of SiO₂ and Si.

16. The reflection-type optical modulator module of claim 15, wherein the anti-reflective thin film has a reflectance of 0 to 1%, and the high-reflective thin film has a reflectance of 99 to 100%.
